(19) United States
(12) Patent Application Publication
(10) Pub. No.: US 2009/0220165 A1
(43) Pub. Date: Sep. 3, 2009

(54) EFFICIENT IMAGE DISPLAYING

(75) Inventors: Zicheng Liu, Bellevue, WA (US); Ying Shan, Plainsboro, NJ (US); Cha Zhang, Sammamish, WA (US); Gang Hua, Bellevue, WA (US); Zhengyou Zhang, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/039,741

(22) Filed: Feb. 29, 2008

(51) Int. Cl. G06K 9/42; G06K 9/32

(52) U.S. Cl. 382/256; 382/298; 382/299

(57) ABSTRACT

Efficient image display on a display screen (e.g., in terms of number, space, resolution, and/or distortion) is facilitated by implementing one or more specialized select and pack routines for images. That is, representative images are selected from an image database, based on desired resolution and distortion, then resized and packed into a display arrangement that enhances use of display screen space. This allows, for example, images to be sent to a user from an image database more quickly, with more desirable resolution, and less distortion than traditional display techniques.

### BACKGROUND

In computing environments, images can be retrieved from an image database and displayed on a variety of display screens. Often, when a user wishes to view images from an image database they are required to continually browse a displayed selection until they find a desired image or images. Therefore, it may be desirable to get images to a user as quickly as possible, in order to reduce browsing time and computer resources. However, because display screens can be limited in size in mobile devices, for example, it may be difficult to display images with appropriate resolution and/or without substantial distortion.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In a computing environment, when one wants to view images on a display screen they have typically been limited to a uniform packing arrangement. For example, if a user inputs a search query into an online search website, the site returns a limited display of some of the images from all of those meeting the search criteria. If a user is looking for a particular item, for example, from a shopping website, browsing all of the results returned may be quite cumbersome. Uniform image displays have some limitations, for example, they typically limit the size, location, and/or number of images to be displayed. Due to these limitations, the resulting images are often distorted to fit a certain aspect ratio, or the details cannot be distinguished because the resolution does not appropriately fit the displayed image size. Further, a lot of display space is left blank, often up to 70%, when using a uniform packing arrangement. These problems are particularly exacerbated when the user is accessing the images from a mobile device screen, which is often very limited in size. The ability to get images from an image database to a user as quickly as possible is hampered by this type of uniform packing arrangement. Also, because traditional image search systems typically construct and utilize an image hierarchy scheme for image searching, they are computationally expensive, and may not work efficiently when “browsing on-the-fly” for images.

As provided herein an image select and pack technique is designed to more quickly retrieve representative images from an image database, and resize and display more of them in an efficient packing arrangement, compared to its predecessors. Furthermore, this image select and pack technique is designed to display images having a desirable resolution while minimizing, or substantially reducing, distortion. For example, this select and pack technique may enable a mobile device user to more efficiently shop online by retrieving and displaying a greater number of relevant representative images per display screen, having a resolution and distortion that gives the user a more desirable viewing experience.

To facilitate, at least some of, the same, a clustering algorithm (e.g., an incremental clustering algorithm) divides an image database into image classes, which may be based on particular image characteristics. A representative image is selected from each class and the images are resized and packed into a display arrangement, from which a desired resolution state is determined. A distortion bound is computed for the set of representative images, and if found to be unchanging, the arrangement and distortion bound is collected for this arrangement. If the distortion bound is found to be changing, a new representative image is incrementally selected from a respective image class, and a packing arrangement and resolution state is again determined.

Once a desired distortion bound and packing arrangement is determined for one possible image display number (e.g., 10 images on a display screen), a desired distortion bound and packing arrangement is determined for each possible image display number (e.g., for 11 up to 200 images on a display screen). Once each respective distortion bound and packing arrangement has been determined, the packing arrangement, and corresponding number of images, with the lowest distortion bound, for the screen size, is displayed.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for generating an arrangement of images on a display screen space.

FIG. 2 is a flow diagram illustrating an exemplary method for generating a packed arrangement of images on a display screen space, with desired resolution and distortion.

FIG. 3 is an illustration of an exemplary portion of a method for incrementally selecting images.

FIG. 4 is an illustration of exemplary uniform packing arrangements of images.

FIG. 5 is an illustration of exemplary resized and packed images.

FIG. 6 is a graphical illustration of exemplary curves of image resolution and distortion function values.

FIG. 7 is an illustration of an exemplary computer-readable medium comprising processor-executable instructions configured to embody one or more of the techniques provided herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

In a computing environment, if one wants to search an image database (e.g., an Internet-based image search using specified criteria) the search may return thousands of results, for example. To review the images returned by the search and find the desired image(s), the user may need to view each of the images displayed on the display screen until locating the desired image(s). Images displayed on a display screen are typically arranged in a uniform manner of size and arrangement (e.g., a specified image size, number of images per row, and number of rows). When images are arranged in a uniform manner, the number of images displayed on a display screen is limited by image size and a specified number of images to be displayed. Further, the size of the image displayed is limited by the display arrangement.

Another limiting factor for digital images is their resolution, which can affect image details. For example, a digital image may have a resolution of 800×600, or 480,000 pixels (0.5 megapixels), while another digital photograph may have a resolution of 1600×1200, or 1,920,000 pixels (2 mega pixels), and yet another digital image may have a resolution of 2560×1600, or 4,096,000 pixels (4 mega pixels). When the three images are scaled down in size to fit a display each image will display some distortion compared with the original image. However, because of the differing initial resolutions, each image will have a different amount of distortion when scaled to a uniform size. Further, when images are scaled down in size a certain amount of detail resolution is lost as the details become smaller. However, the amount of detail resolution loss may even vary between images with the same initial resolution. When two images having the same initial image resolution are scaled down, the amount of detail resolution perceived by human vision may depend on the content of the image, as an image with fine detail or a lot of content may be perceived differently when scaled down than an image with little detail or minimal content. For example, where two images that have the same original resolution (e.g., 1600×1200) are both scaled down to the same coarse resolution (e.g., 40×30), each of the images may lose a different amount of visual details (particularly where human vision is used to perceive the two low resolution images). The loss of visual details in the different images is a function of the specific content of the images because humans interpret different visual objects in different ways. Accordingly, the difference in distortion when scaled down to a uniform size is not only affected by the initial resolution, but also by the image content. This also explains why certain images can be scaled into a very small size without affecting what is in the scene, while for other images substantially scaling down the images may make it difficult to interpret what is in the scene.

Content on the Internet, including images, continues to increase exponentially. However, display screens for image retrieval systems are limited by functionality. For example, computer monitor sizes are typically limited to the size of a user's work space, the size of a laptop computer, or the limitations prescribed by a system in which a monitor is installed. Further, image display screens are often components of mobile phones, personal digital assistants (PDAs), and other portable electronic devices. As such, when a user wishes to explore a large database of images, the time needed to visually scan the images is a function of the number of images that can be effectively displayed on a display screen at any one time. As one example, a user may wish to use an Internet-based search engine to search for images related to “teddy bears.” Such a search may return over 700,000 images results. If the user is interested in finding only those images containing a photograph of a single stuffed teddy bear, and only of a particular type, the user may have to visually scan each of the returned image results until they find the image(s) that meet their criteria. The problem of exploring an image database can be formulated as a communications channel problem, where an image database is a source, a display screen is a channel, and a user is a receiver. An objective is to transfer as many images as possible from the source to the receiver under the constraints of the channel.

In order to speed transfer of images to a user, and therefore increase channel capacity, a user may choose to increase the number of images displayed on each display screen. However, if images are arranged in a uniform manner, for example, the number of images displayed on a display screen will be limited by the user's ability to resolve image details. If a user cannot effectively resolve image details, a visual scan of images in an image database may not yield desired results. Additionally, decreasing an image's size may distort the image and reduce the image's resolution. A combination of image distortion, decreased resolution and an increased number of images decreases the user's ability to resolve the details of an image. This affect may be further exacerbated, for example, if images are placed in closer proximity to each other. Also, for example, if the user's display screen is smaller (e.g., a mobile phone or PDA), the number of images that may effectively be displayed is further limited by the display screen size.

One technique for displaying images on a display screen, while attempting to maintain effective resolution, is to allow images to be displayed in predetermined, non-uniform sizes, based on original image size. Because an image stored in an image database may have an initial resolution (e.g., 0.5 megapixels, 2 megapixels, 4 megapixels), reducing larger images that have more detail to the same size as a smaller image with less detail, may lead to increased loss of resolution. Using this technique, for example, one may reduce the size of an image to a predetermined level, based on original image size, which may mitigate loss of resolution. Therefore, the size of an image displayed on a display screen will be a function of the size of an original image in an image database. For example, if the size of an original image in an image database is 800×600 it may be displayed in a predetermined, small size on a display screen; whereas an original image having a size of 2560×1600 may be display in a predetermined, large size on the display screen. However, while this technique may mitigate some loss of resolution of images, it still does not account for an image's content when determining display resolution, it doesn't allow for efficient arrangement of images on a display screen, and does not effectively account for each image's resolution. This technique utilizes predetermine image sizes based on the original image size, which may not properly account for an image's resolution, leading to loss of resolution for some displayed images. Further, reducing images of similar resolutions, but having different content, to a smaller size may also lead to increased loss of resolution. Also, it utilizes a method of uniform arrangement of images on a display screen, therefore, the number of images displayed is still limited by the uniform arrangement criteria (e.g., preset number of columns and rows) and the resolution of the displayed images (e.g., the more images on a screen means smaller images, leading to lower resolution).

An alternate technique, as provided herein, for displaying images on a display screen, while maintaining effective resolution and minimizing, or substantially reducing, distortion, is to allow images to be displayed in non-uniform sizes based on resolution, content, and distortion, while generating a non-uniform, image packing arrangement that efficiently utilizes display space on a display screen. An image's intrinsic resolution (e.g., the resolution value that corresponds to a designated display distortion value on a curve of a display distortion function) may be determined, which allows one to set the desired (e.g., smallest) display size value for an image that stills maintains an effective resolution for viewing, taking into account the image's content. Further, images may be resized and packed into an arrangement that efficiently utilizes a displays screen's display space. Also, image results returned from a search query, for example, can be summarized or browsed on-the-fly utilizing incremental selection, instead of by creating and using an image hierarchy scheme. This technique may be implemented by combining the determination of an image's resolution and distortion, efficiently packing the arrangement of images, and incrementally selecting images from an image database.

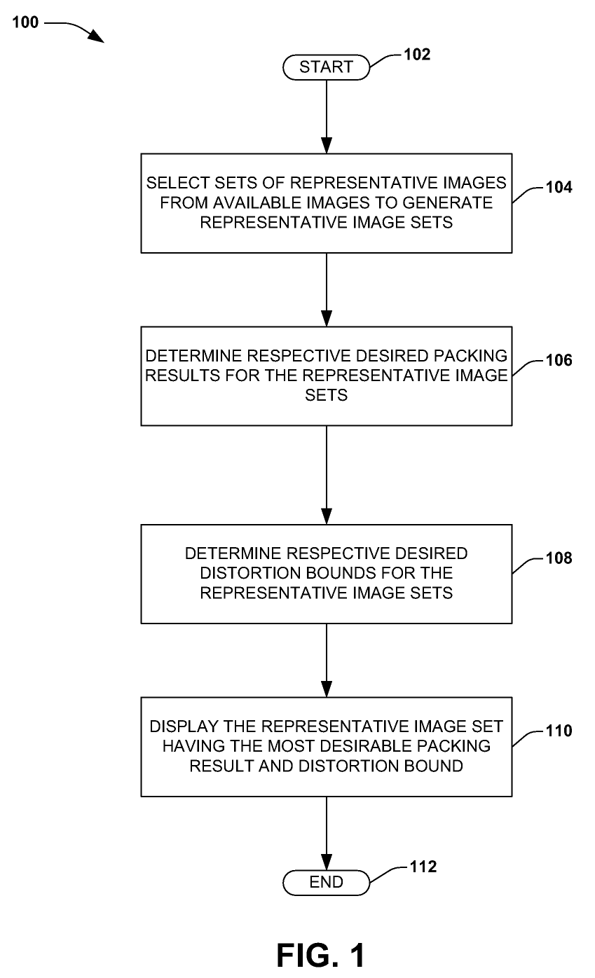

FIG. 1 illustrates an exemplary method 100, devised to generate a packed arrangement of images that efficiently utilizes a display screen space, with desired image resolution, and desired (e.g., minimal) distortion, while browsing an image database on-the-fly. Exemplary method 100 starts at 102 and selects sets of representative images from available images and generates representative image sets at 104. At 106, respective packing results are determined for the respective representative image sets. At 108, desired distortion bounds are determined for respective representative image sets. Once respective packing results and desired distortion bounds have been determined at 106 and 108, the exemplary method displays the representative image set having the most desirable packing results and distortion bounds at 110. The exemplary method 100 then ends at 112.

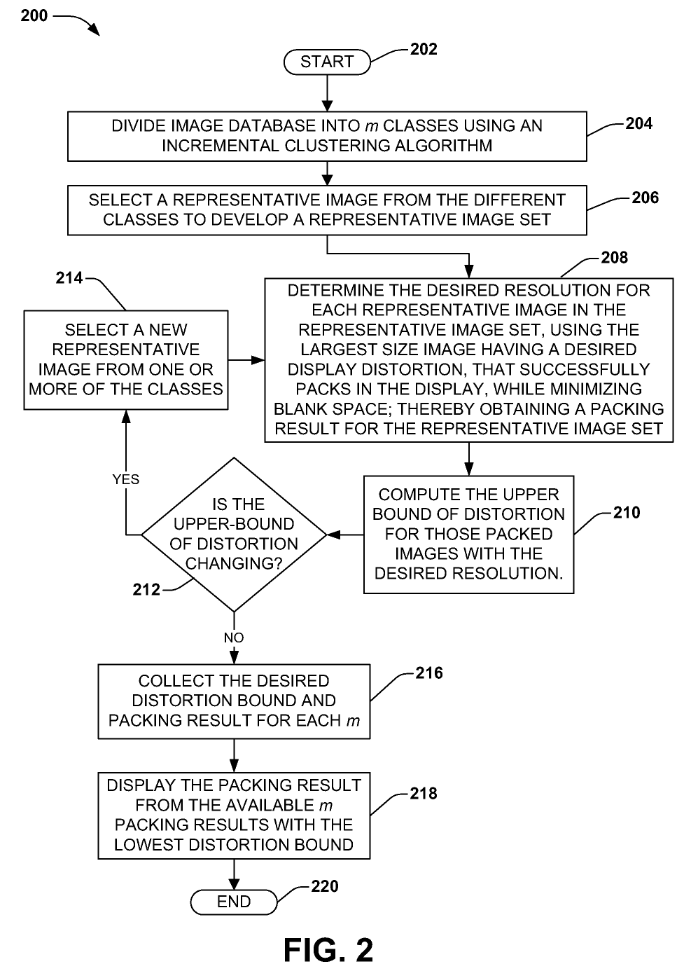

One example of the exemplary method 100 in FIG. 1 is illustrated in FIG. 2, by exemplary method 200. Exemplary method 200 begins at 202 and uses a clustering algorithm (e.g., an incremental clustering algorithm) to divide the image database (e.g., the image results returned by an Internet-based image search) into a number of image classes represented by a variable m at 204. The variable m, in this example, represents a number of images to be displayed on a display screen at one time (e.g., if 40 images are to be displayed m=40). At 206, a representative image from each of the m image classes is selected and placed into a representative image set. At 208, a desired resolution for each representative image in the representative image set is determined by finding a desired (e.g., the largest) size, of the representative image, having a desired display distortion, and that successfully packs in a display arrangement that minimizes, or substantially reduces, unfilled space, which yields a packing result for the representative image set. At 210, an upper-bound of distortion is computed for the images in the packing result from 208. If the upper-bound of distortion from 210 is found to be actively changing, a new representative image is selected from one or more of the image classes generated in 206, at 214. After selecting one or more representative images the exemplary method 200 returns to 208, where a new packing result is obtained for a new representative image set. This process (e.g., 212→214→208→210) is continued until an upper-bound of distortion is determined to not be actively changing for a packed representative image set. After determining the upper-bound of distortion is not actively changing for a packed representative image set, at 216 the exemplary method 200 collects a desired distortion bound and packing result for the representative image set of m (e.g., if m=40, the optimal distortion bound and packing result is collected for a display of 40 images). At 216, the exemplary method 100 collects desired distortion bounds and packing results for each potential m (e.g., m=10, 11, 12, . . . 200), therefore, at 216 the exemplary method 200 collects desired distortion bounds and packing results for each potential m. After collecting desired distortion bounds and packing results for each potential m, at 218 the packing result of m images having the lowest distortion bound is displayed. Exemplary method 200 then ends at 220.

As an example of one embodiment of the technique described herein, a user of a wireless mobile device, wishing to shop for jewelry online (e.g., on the Internet), navigates to a shopping website and inputs the search term “jewelry.” The user may find over 5,000 products listed in one of the jewelry categories. Finding a desired product from any one of the categories may prove to be a long and cumbersome browsing experience, particularly if the display screen size is that of a small mobile device. Here, the alternative technique can select representative images from a database of images in a category of jewelry selected by the user, then resize and pack the images in an arrangement that fits a mobile device's screen. This type of image selection and packing may enable the user to browse images of jewelry more efficiently, with a more desirable resolution, and less distortion than previous techniques.

In one aspect, one can browse an image database on-the-fly by utilizing incremental image selection. In contrast, existing techniques typically rely on construction of a complete image hierarchy, which is computationally expensive. In this aspect, for example, a clustering algorithm (e.g., an incremental clustering algorithm) is used to divide an image database into image classes, which may be based on image characteristics (e.g., color, gradient, image features, image similarity) using search results from traditional user queries (e.g., combinations comprising text category, color, shape, and/or brand). A representative image is then selected from each of the image classes, for example, from the center of an image class cluster of images. These selected representative images are placed in a representative image set. If the representative image set does not meet criteria set forth in other aspects described herein, a new representative image is selected from one or more of the respective image classes, for example, by incrementally selecting the next image in the respective image class cluster (e.g., selecting an image next to the center image). By utilizing this incremental image selection process a display screen may be populated with search relevant images, without having to construct a complete image hierarchy, which allows browsing of images on-the-fly.

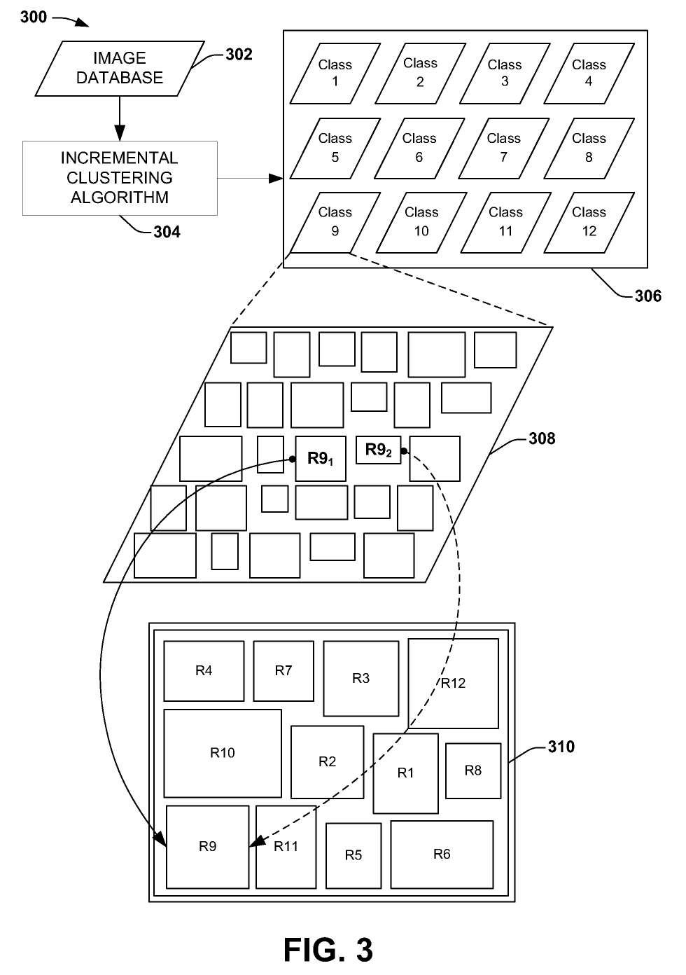

FIG. 3 illustrates portions of an exemplary method 300 for incremental selection of representative images. An exemplary image database 302, for example, is subjected to a clustering algorithm (e.g., an incremental clustering algorithm) 304. In this example, the clustering algorithm 304 divides the image database 302 into a set of image classes represented in 306. An exemplary exploded view of exemplary image class 9 is shown in 308. The exemplary method 300 selects a representative image from image classes 9, selecting the center image R9₁ in 308. The exemplary representative image R9₁ is sent to a representative image set 310, which is made up of representative images from each of the image classes from 306. In this example, if another representative image is called, for example, the exemplary method 300 incrementally selects a next image R9₂ in the image class 308. R9₂ replaces R9₁ in the representative image set 310.

In another aspect, selected images may be efficiently arranged onto a display screen by resizing the images and packing them in such a way as to minimize, or substantially reduce, blank space on the display screen. In contrast, existing techniques typically arrange images using a uniform packing arrangement (e.g., a specified number of images per row and a specified number of rows), displaying images in a uniform manner. A uniform packing arrangement often leaves a lot of blank space on a display screen (e.g., 70% of the screen space may be blank), which does not allow for an efficient display of images. In this aspect, for example, images in a representative image set are resized and packed into an arrangement that minimizes, or substantially reduces, blank space on the display screen, based on the display screen size and aspect ratio. None of the images may overlap each other, nor may they overlap the edges of the display screen space. By utilizing this resize and pack process, selected images may be efficiently displayed on a display screen, minimizing, or substantially reducing, blank space and utilizing more of the display screen to display selected images. By efficiently utilizing the display screen (e.g., the channel to transfer images from the source to the receiver), for example, the user may decrease time needed to view images from an image database.

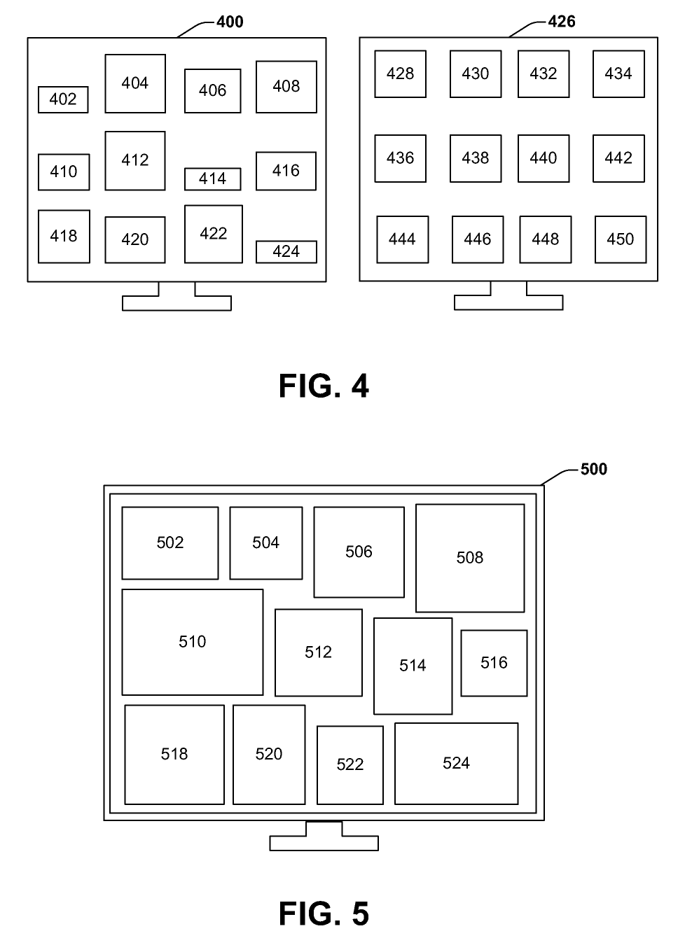

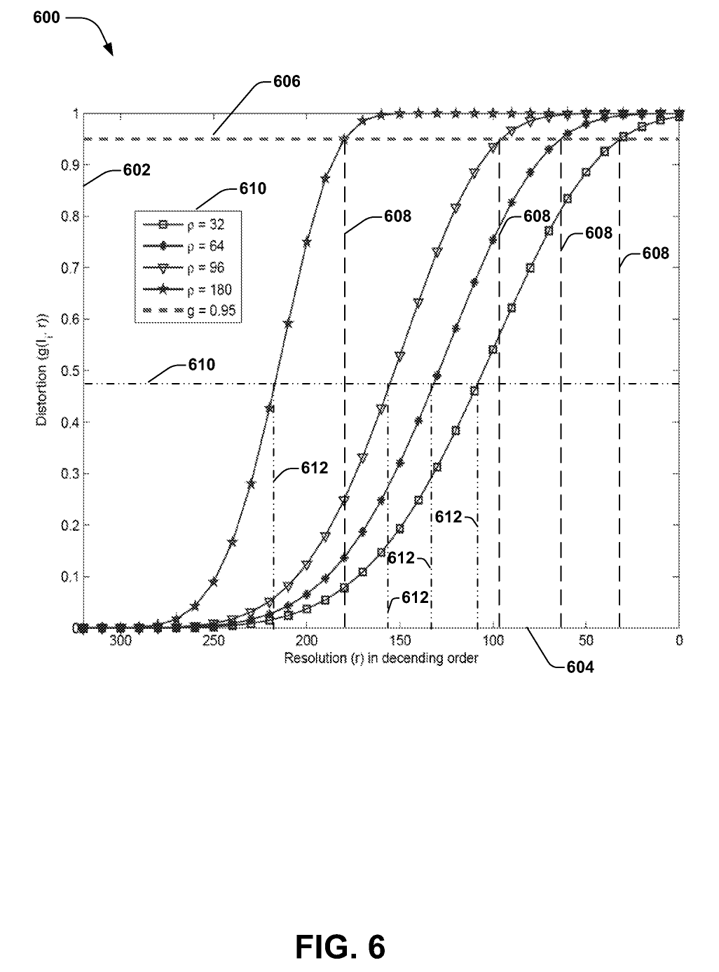

FIG. 4 is an illustration of exemplary display screens using uniform packing arrangements for images. Exemplary display screen 400 illustrates a uniform packing arrangement that allows resizing of images, but allots a specific amount of space in a specific location for each image. Exemplary display screen 400 shows images 402-424 that have been resized and placed in specific locations on the screen. Because a specified amount of display space is allotted for each image, diminished resolution may be experienced, especially in images 402, 414 and 424, for example. Exemplary display screen 426 illustrates a uniform packing arrangement that allots a specific amount of space in a specific location for each image, and resizes each image to fit that allotted space. Exemplary display screen 426 shows images 428-450 that have been resized to a specified sized and placed in specific locations on the screen. Because each image is sized to meet the specified amount of display space allotted, a certain amount of distortion and diminished resolution may be experienced, in each of the exemplary images 428-450, for example. In contrast, FIG. 5 is an illustration of an exemplary display screen wherein images are packed and arranged as provided herein. Exemplary display screen 500 illustrates that each image 502-524 has been resized and packed in a way, for example, that minimizes, or substantially reduces, blank space. Further, the packing arrangement of exemplary display screen 500, for example, accounts for an images original resolution in order to minimize, or substantially reduce, distortion and provide desired (e.g., maximized) resolution.

In another aspect, images may be selected for display and resized based on resolution and distortion characteristics. For example, images in a representative image set are subjected to a method whereby a desired resolution state of the image is determined, corresponding to an image packing arrangement for the representative image set. In contrast, uniform packing arrangements do not typically account for image resolution; therefore image detail can be lost when image sizes are reduced in a uniform manner. In this aspect, for example, when given a curve (e.g., f:g(l,r),r) that represents the relationship between display distortion function values (e.g., value of g in the function g(l,r)) and image resolution values (e.g., r=resolution width of an image), the method computes the largest size for an image that will successfully pack into a display arrangement containing all of the representative images in the set, while maintaining a resolution that approximately corresponds to a display distortion function value on the curve, which approximates a midpoint between 0 and a value corresponding to the image's intrinsic resolution value from the curve.

FIG. 4 is graph of an exemplary curve 600, f:g(l,r), r. In this example, the x axis 604 corresponds to resolution values (r) for an image (e.g., an image's width resolution value), and the y axis 602 corresponds to distortion function values (g), from a distortion function g(l, r), for an image. The exemplary curve maps values of r 610 corresponding to an image's intrinsic resolution value. In this example, the intrinsic resolution value of an image can be shown as the r value 608 that intersects the curve at a point corresponding to a g value of 0.95 606. Further, the graph illustrates a resolution value 612 that approximately corresponds to a display distortion function value on the curve, which approximates a midpoint 610 between 0 and a value corresponding to the image's intrinsic resolution value from the curve 606.

At this point, for example, the method has determined an image's desired resolution state for a corresponding packing arrangement of the representative image set. Given a resolution state of the images in a packing arrangement for a representative image set, combined with image database classification results, the method determines an upper-bound of distortion for the images in the representative image set. For example, quantization distortion is created by selecting different representative images from different image classes when generating a representative image set. In this example, quantization distortion is characterized as a potential loss of images resulting from the method collecting a subset (e.g., representative images) of an image database. When quantization distortion is determined for each representative image with respect to all images belonging to a corresponding image class, and combined with display distortion for each representative image, an upper-bound of distortion (e.g., total distortion=combination of quantization and display distortion) can be determined. The method then determines whether the upper-bound of distortion is actively changing, which is based on a location and size of representative images in a packing arrangement. In this example, finding a lowest upper-bound of distortion for a packed arrangement of representative images is desirable. If the upper-bound of distortion is actively changing, for example, the method incrementally selects another image in a corresponding image class to be a new representative image in a new representative image set. For images in the new representative image set, the method once again determines a desired resolution, corresponding to an image packing arrangement, for the new representative image set. The method continues a cycle of selecting representative images and determining desired resolution states for a packing arrangement, until an unchanging upper-bound of distortion is computed for a representative image set. By computing an unchanging, lowest upper-bound of distortion for a representative image set, for example, images from an image database may be selected for display and resized based on resolution state and distortion. This selection and resizing, for example, may allow display of representative images having a desired resolution and packing, with desired distortion.

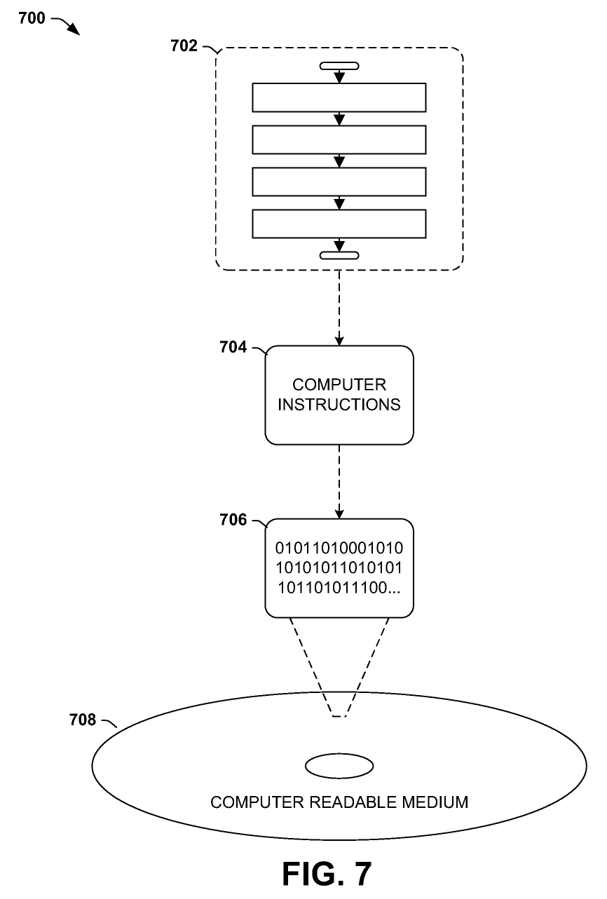

Another embodiment (which may include one or more of the variations described above) involves a computer-readable medium comprising processor-executable instructions configured to apply one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to the principles set forth herein. In one such embodiment, the processor-executable instructions 704 may be configured to perform a method 702 for displaying images on a display screen, while maintaining effective resolution and minimizing, or substantially reducing, distortion, such as the method 100 of FIG. 1, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

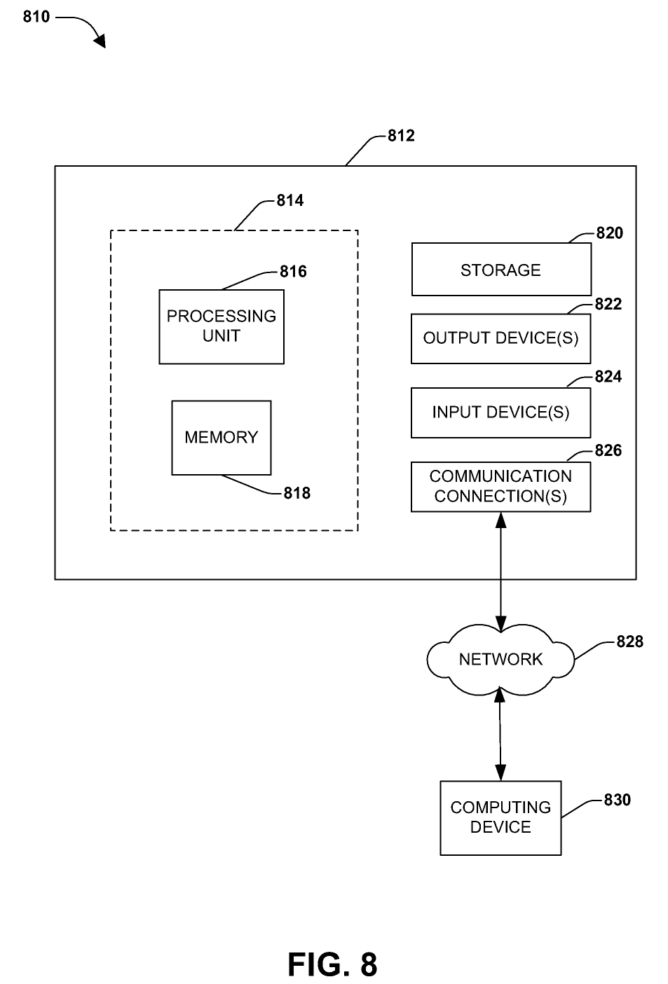

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 8394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for efficiently displaying images in a computing environment, comprising:
selecting sets of representative images from available images to generate representative image sets;
determining respective desired packing results for the representative image sets;
determining respective desired distortion bounds for the representative image sets; and
displaying the representative image set having the most desirable packing result and distortion bound.

2. The method of claim 1, the representative images corresponding to different image classes such that a representative image set comprises an image from the different image classes.

3. The method of claim 1, the sets of representative images comprising:
a number of sets corresponding to a potential maximum number of images that can be displayed on the display.

4. The method of claim 3, the potential maximum number of images calculated by using intrinsic resolutions of an image database.

5. The method of claim 4, the intrinsic resolution of an image comprises a resolution value corresponding to a predetermined display distortion value in a display distortion function curve for an image.

6. The method of claim 2, image classes generated from the available images by a clustering algorithm.

7. The method of claim 1, comprising displaying the representative image set having the packing result associated with the lowest distortion bound.

8. The method of claim 1, determining respective desired packing results for the representative image sets comprising:
determining respective desired resolution states for the representative images in the representative image sets; and
choosing those images for respective representative image sets that have a desired resolution state to comprise the desired packing results for the respective representative image sets.

9. The method of claim 8, determining respective desired resolution states comprising:
resizing the respective representative images in the different representative image sets to efficiently utilize space on a display; and
determining a desired display distortion for the respective representative images in the different representative image sets.

10. The method of claim 8 choosing those images for respective representative image sets comprising:
setting an initial representative image to a center of an image class;
choosing the initial representative image; and
for respective representative images chosen, incrementally select a next image in the image class.

11. The method of claim 1, determining respective desired distortion bounds for the representative image sets comprising:
calculating an upper bound of distortion for the representative images in the representative image sets; and
selecting the set of representative images that are calculated to have an unchanging upper bound of distortion.

12. The method of claims 11, comprising:
determining whether the upper bound of distortion is actively changing for a set of selected representative images.

13. A computer-readable medium comprising processor-executable instructions configured to implement the method of claim 1.

14. A method for efficiently displaying images in a computing environment, comprising:
placing a set of images into different arrangements to obtain different packing results, the images resized in the different arrangements to efficiently use space on a display;
determining respective resolution states for the images as the images are resized and placed into the different arrangements; and
displaying a desired packing result where the respective resolution states for the images corresponds to desired resolution states.

15. The method of claim 14, comprising:
determining respective distortion bounds for the images as the images are resized and placed into the different arrangements; and
displaying a desired packing result where the respective distortion bounds for the images corresponds to desired distortion bounds.

16. The method of claim 14, comprising:
selecting an image from different image classes such that the set of images is a representative image set that comprises a representative image from the different image classes.

17. The method of claim 16, comprising:
obtaining more than one representative image set;
determining respective desired packing results for the different representative image sets; and
displaying the most desired packing result from the different packing results.

18. The method of claim 14, determining respective resolution states comprising:
selecting a resolution state for an image corresponding to a desired display distortion; and
selecting a resolution state for an image corresponding to a desired display packing arrangement.

19. The method of claim 18, a desired display distortion being a function of an image's intrinsic resolution.

20. A method for efficiently displaying images in a computing environment, comprising:
selecting sets of representative images from available images to generate representative image sets, the representative images corresponding to different image classes such that a representative image set comprises an image from the different image classes, the image classes generated from the available images by a clustering algorithm;
determining respective desired packing results for the representative image sets, comprising:
determining respective desired resolution states for the representative images in the representative image sets; and
choosing those images for respective representative image sets that have a desired resolution state to comprise the desired packing results for the respective representative image sets.
determining respective desired distortion bounds for the representative image sets, comprising:
calculating an upper bound of distortion for the representative images in the representative image sets; and
selecting the set of representative images that are calculated to have an unchanging upper bound of distortion; and
displaying the representative image set having the most desirable packing result and distortion bound, comprising displaying the representative image set having the packing result associated with the lowest distortion bound.
